(19) United States
(12) Patent Application Publication
(10) Pub. No.: US 2024/0127149 A1
(43) Pub. Date: Apr. 18, 2024

(54) SYSTEMIZING ORGANIZATIONAL DESIGN USING ARTIFICIAL INTELLIGENCE

(71) Applicant: JPMorgan Chase Bank, N.A., New York, NY (US)

(72) Inventors: Sameena SHAH, Scarsdale, NY (US); Guy HALAMISH, London (GB)

(73) Assignee: JPMorgan Chase Bank, N.A., New York, NY (US)

(21) Appl. No.: 17/966,448

(22) Filed: Oct. 14, 2022

(51) Int. Cl. G06Q 10/06

(52) U.S. Cl. CPC G06Q 10/0633; G06Q 10/063112; G06Q 10/06316

(57) ABSTRACT

Methods and systems for optimizing a design of an organization by using artificial intelligence (AI)-based automation to orchestrate a structure of jobs, roles, and task assignments so as to improve business outcomes are provided. The method includes: receiving a first task description that includes information that relates to each of a set of sub-tasks; analyzing the first task description by applying an artificial intelligence (AI) algorithm that uses a machine learning technique to analyze each respective sub-task; and determining, based on a result of the analysis, a task management plan that includes information that relates to a respective personnel assignment and a respective schedule for each respective sub-task.

### BACKGROUND

### 1. Field of the Disclosure

This technology generally relates to methods and systems for designing an organizational structure, and more particularly to methods and systems for optimizing a design of an organization by using artificial intelligence (AD-based automation to orchestrate a structure of jobs, roles, and task assignments so as to improve business outcomes.

### 2. Background Information

With the increased use of artificial intelligence (AI) deployments, organizations are presented with the opportunity to reconsider and optimize their organization design. Specifically, this is facilitated because of AI-based automation that reshapes how parts of certain jobs/roles are performed, and AI-driven insights that surface opportunities to redesign organization to optimize business outcomes.

In many large organizations, end-to-end tasks are divided across teams with differing roles. For example, one common task that is performed in many organizations entails gathering information and creating a client record for client onboarding. This end-to-end task may be accomplished by several teams that need to interact often with each other and with external clients. From an organizational design perspective, the end-to-end client onboarding task may be split across different functional teams, such as, for example, a sales team, a know-your-customer (KYC) team, a credit team, a legal team, and a data team. Within each function, a team may be further split into different specialty teams. For example, a KYC team may constitute of three types of functional roles that work together to create a KYC record for a client. Given skills and locations of employees, the teams may have settled into various communication patterns and roles.

Accordingly, there is a need for a method for optimizing a design of an organization by using AI-based automation to orchestrate a structure of jobs, roles, and task assignments so as to improve business outcomes.

### SUMMARY

The present disclosure, through one or more of its various aspects, embodiments, and/or specific features or sub-components, provides, inter alia, various systems, servers, devices, methods, media, programs, and platforms for methods and systems for optimizing a design of an organization by using AI-based automation to orchestrate a structure of jobs, roles, and task assignments so as to improve business outcomes.

According to an aspect of the present disclosure, a method for optimizing a design of an organization is provided. The method is implemented by at least one processor. The method includes: receiving, by the at least one processor, a first task description that includes information that relates to each of a plurality of sub-tasks; analyzing, by the at least one processor, the first task description; and generating, by the at least one processor based on a result of the analyzing, a task management plan that includes information that relates to a respective personnel assignment and a respective schedule for each respective sub-task of the plurality of sub-tasks.

The analyzing of the first task description may include applying an artificial intelligence (AI) algorithm that uses a machine learning technique to analyze each respective sub-task of the plurality of sub-tasks.

The AI algorithm may be trained by using historical data that relates to a predetermined set of previously completed tasks.

The generating of the task management plan may include optimizing the task management plan with respect to at least one predetermined criterion. The at least one predetermined criterion may include at least one from among reducing cost, increasing timeliness, maximizing worker efficiency, enhancing client experience, reducing risk, minimizing inter-team dependency, and enhancing employee satisfaction.

The first task description may include a description of a task that includes at least one know-your-customer (KYC) functionality to be performed in a course of onboarding a new client.

The first task description may include a description of a task that includes at least one client inquiry resolution functionality to be performed in a course of responding to a client inquiry.

The analyzing may include assessing a volume of communications required among persons assigned to perform the plurality of sub-tasks.

The task management plan may include information that relates to communications requirements for performing the plurality of sub-tasks.

The analyzing may include determining, for each respective one of the plurality of sub-tasks, whether the respective sub-task is performable in parallel with other sub-tasks from among the plurality of sub-tasks.

The analyzing may include: determining, for each respective one of the plurality of sub-tasks, a corresponding skill set that is required for performing the respective sub-task; and identifying at least one person that possesses the corresponding skill set.

According to another exemplary embodiment, a computing apparatus for optimizing a design of an organization is provided. The computing apparatus includes a processor; a memory; and a communication interface coupled to each of the processor and the memory. The processor is configured to: receive, via the communication interface, a first task description that includes information that relates to each of a plurality of sub-tasks; analyze the first task description; and generate, based on a result of the analysis, a task management plan that includes information that relates to a respective personnel assignment and a respective schedule for each respective sub-task of the plurality of sub-tasks.

The processor may be further configured to analyze the first task description by applying an artificial intelligence (AI) algorithm that uses a machine learning technique to analyze each respective sub-task of the plurality of sub-tasks.

The AI algorithm may be trained by using historical data that relates to a predetermined set of previously completed tasks.

The processor may be further configured to optimize the task management plan with respect to at least one predetermined criterion. The at least one predetermined criterion may include at least one from among reducing cost, increasing timeliness, maximizing worker efficiency, enhancing client experience, reducing risk, minimizing inter-team dependency, and enhancing employee satisfaction.

The first task description may include a description of a task that includes at least one know-your-customer (KYC) functionality to be performed in a course of onboarding a new client.

The first task description may include a description of a task that includes at least one client inquiry resolution functionality to be performed in a course of responding to a client inquiry.

The processor may be further configured to assess a volume of communications required among persons assigned to perform the plurality of sub-tasks.

The task management plan may include information that relates to communications requirements for performing the plurality of sub-tasks.

The processor may be further configured to determine, for each respective one of the plurality of sub-tasks, whether the respective sub-task is performable in parallel with other sub-tasks from among the plurality of sub-tasks.

The processor may be further configured to: determine, for each respective one of the plurality of sub-tasks, a corresponding skill set that is required for performing the respective sub-task; and identify at least one person that possesses the corresponding skill set.

According to yet another exemplary embodiment, a non-transitory computer readable storage medium storing instructions for optimizing a design of an organization is provided. The storage medium includes executable code which, when executed by a processor, causes the processor to: receive a first task description that includes information that relates to each of a plurality of sub-tasks; analyze the first task description; and generate, based on a result of the analysis, a task management plan that includes information that relates to a respective personnel assignment and a respective schedule for each respective sub-task of the plurality of sub-tasks.

When executed by the processor, the executable code may further cause the processor to analyze the first task description by applying an artificial intelligence (AI) algorithm that uses a machine learning technique to analyze each respective sub-task of the plurality of sub-tasks.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for optimizing a design of an organization by using AI-based automation to orchestrate a structure of jobs, roles, and task assignments so as to improve business outcomes.

FIG. 4 is a flowchart of an exemplary process for implementing a method for optimizing a design of an organization by using AI-based automation to orchestrate a structure of jobs, roles, and task assignments so as to improve business outcomes.

FIG. 5 is a graphical depiction of an organizational design that is usable for performing a method for optimizing a design of an organization by using AI-based automation to orchestrate a structure of jobs, roles, and task assignments so as to improve business outcomes, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

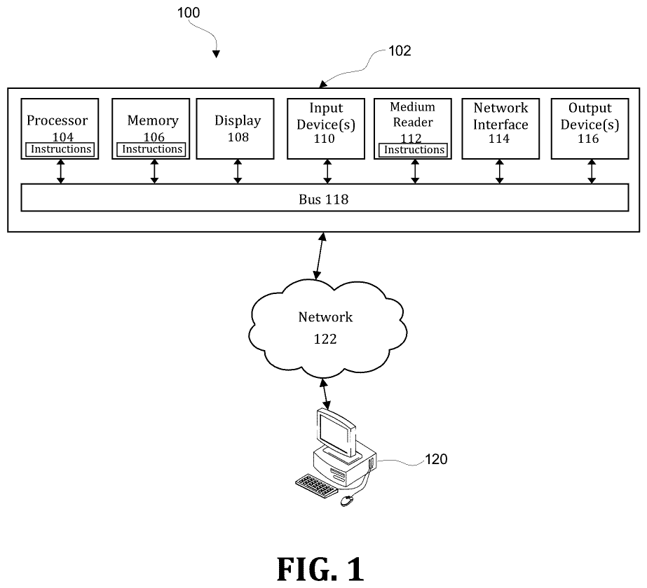

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for optimizing a design of an organization by using artificial intelligence (AI)-based automation to orchestrate a structure of jobs, roles, and task assignments so as to improve business outcomes.

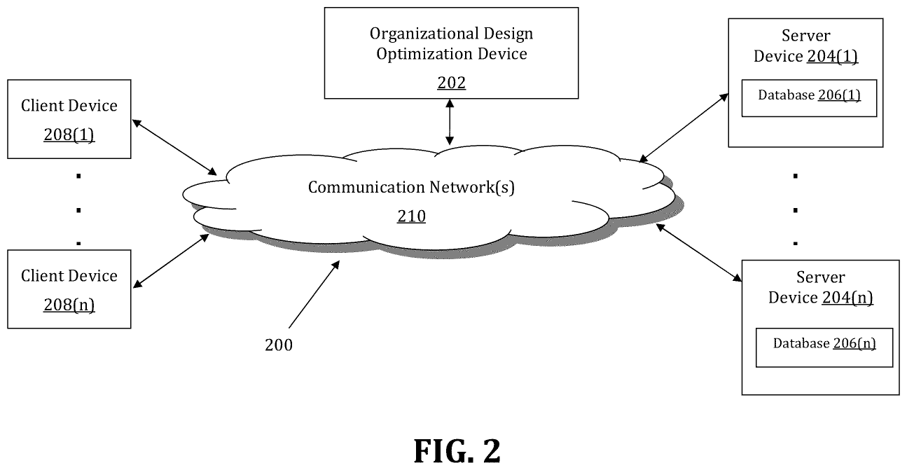

Referring to FIG. 2, a schematic of an exemplary network environment 200 for implementing a method for optimizing a design of an organization by using AI-based automation to orchestrate a structure of jobs, roles, and task assignments so as to improve business outcomes is illustrated. In an exemplary embodiment, the method is executable on any networked computer platform, such as, for example, a personal computer (PC).

The method for optimizing a design of an organization by using AI-based automation to orchestrate a structure of jobs, roles, and task assignments so as to improve business outcomes may be implemented by an Organizational Design Optimization (ODO) device 202. The ODO device 202 may be the same or similar to the computer system 102 as described with respect to FIG. 1. The ODO device 202 may store one or more applications that can include executable instructions that, when executed by the ODO device 202, cause the ODO device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ODO device 202 itself, may be located in virtual server(s) running in a cloud-based computing environment rather than being tied to one or more specific physical network computing devices. Also, the application(s) may be running in one or more virtual machines (VMs) executing on the ODO device 202. Additionally, in one or more embodiments of this technology, virtual machine(s) running on the ODO device 202 may be managed or supervised by a hypervisor.

In the network environment 200 of FIG. 2, the ODO device 202 is coupled to a plurality of server devices 204(1)-204(n) that hosts a plurality of databases 206(1)-206(n), and also to a plurality of client devices 208(1)-208(n) via communication network(s) 210. A communication interface of the ODO device 202, such as the network interface 114 of the computer system 102 of FIG. 1, operatively couples and communicates between the ODO device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ODO device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and ODO devices that efficiently implement a method for optimizing a design of an organization by using artificial intelligence (AI)-based automation to orchestrate a structure of jobs, roles, and task assignments so as to improve business outcomes.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The ODO device 202 may be a standalone device or integrated with one or more other devices or apparatuses, such as one or more of the server devices 204(1)-204(n), for example. In one particular example, the ODO device 202 may include or be hosted by one of the server devices 204(1)-204(n), and other arrangements are also possible. Moreover, one or more of the devices of the ODO device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the ODO device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to historical task assignments and executions and information that relates to organizational structures.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the ODO device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the ODO device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the ODO device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ODO device 202, the server devices 204(1)-204(n), or the client devices 208(1)-208(n), for example, may be configured to operate as virtual instances on the same physical machine. In other words, one or more of the ODO device 202, the server devices 204(1)-204(n), or the client devices 208(1)-208(n) may operate on the same physical device rather than as separate devices communicating through communication network(s) 210. Additionally, there may be more or fewer ODO devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

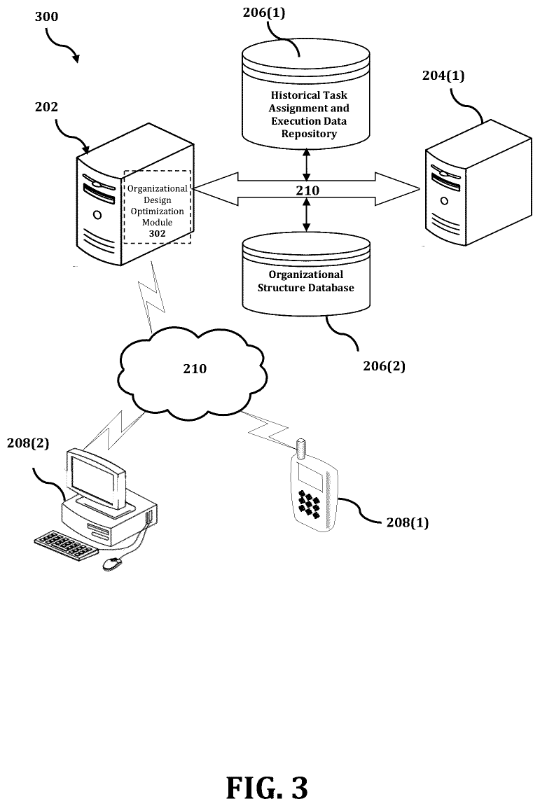

The ODO device 202 is described and illustrated in FIG. 3 as including an organizational design optimization module 302, although it may include other rules, policies, modules, databases, or applications, for example. As will be described below, the organizational design optimization module 302 is configured to implement a method for optimizing a design of an organization by using AI-based automation to orchestrate a structure of jobs, roles, and task assignments so as to improve business outcomes.

An exemplary process 300 for implementing a mechanism for optimizing a design of an organization by using AI-based automation to orchestrate a structure of jobs, roles, and task assignments so as to improve business outcomes by utilizing the network environment of FIG. 2 is illustrated as being executed in FIG. 3. Specifically, a first client device 208(1) and a second client device 208(2) are illustrated as being in communication with ODO device 202. In this regard, the first client device 208(1) and the second client device 208(2) may be “clients” of the ODO device 202 and are described herein as such. Nevertheless, it is to be known and understood that the first client device 208(1) and/or the second client device 208(2) need not necessarily be “clients” of the ODO device 202, or any entity described in association therewith herein. Any additional or alternative relationship may exist between either or both of the first client device 208(1) and the second client device 208(2) and the ODO device 202, or no relationship may exist.

Further, ODO device 202 is illustrated as being able to access a historical task assignment and execution data repository 206(1) and an organizational structure database 206(2). The organizational design optimization module 302 may be configured to access these databases for implementing a method for optimizing a design of an organization by using AI-based automation to orchestrate a structure of jobs, roles, and task assignments so as to improve business outcomes.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the ODO device 202 via broadband or cellular communication. Of course, these embodiments are merely exemplary and are not limiting or exhaustive.

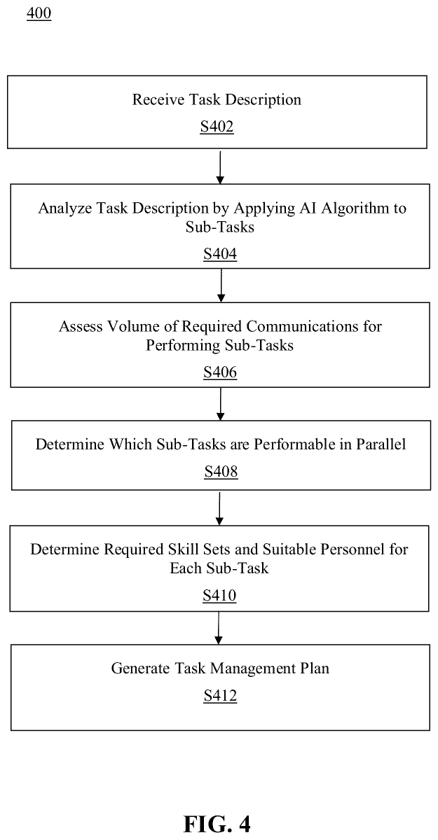

Upon being started, the organizational design optimization module 302 executes a process for optimizing a design of an organization by using AI-based automation to orchestrate a structure of jobs, roles, and task assignments so as to improve business outcomes. An exemplary process for optimizing a design of an organization by using AI-based automation to orchestrate a structure of jobs, roles, and task assignments so as to improve business outcomes is generally indicated at flowchart 400 in FIG. 4.

In process 400 of FIG. 4, at step S402, the organizational design optimization module 302 receives a description of a task. In an exemplary embodiment, the task includes a plurality of sub-tasks, and historically, similar tasks have been performed by assigning various sub-tasks to various different teams within an organization. In an exemplary embodiment, the task description may include a description of a task that includes at least one know-your-customer (KYC) functionality to be performed in the course of onboarding a new client. In an alternative embodiment, the task description may include a description of a task that includes at least one client inquiry resolution functionality to be performed in the course of responding to a client inquiry.

At step S404, the organizational design optimization module 302 analyzes the task description received in step S402. In an exemplary embodiment, the analysis entails applying an artificial intelligence (AI) algorithm that uses a machine learning technique to analyze each respective sub-task included in the task. In an exemplary embodiment, the AI algorithm may be trained by using historical data that relates to a predetermined set of previously completed tasks.

At step S406, the organizational design optimization module 302 assesses a volume of communications that are required among persons assigned to perform various sub-tasks from among the plurality of tasks.

At step S408, the organizational design optimization module 302 determines which sub-tasks are able to be performed in parallel with the performance of other sub-tasks, and which sub-tasks are required to be performed serially in a particular sequential order.

At step S410, for each respective sub-task included in the task, the organizational design optimization module 302 determines a corresponding skill set that is required for performing the respective sub-task, and then identifies candidate personnel that possess the corresponding skill set.

At step S412, the organizational design optimization module 302 uses results of the analysis performed in step S404, the assessment performed in step S406, and the determinations made in steps S408 and S410 to generate a task management plan that includes information that relates to a respective personnel assignment and a respective schedule for each respective sub-task included in the task. In an exemplary embodiment, the task management plan also includes information that relates to communication requirements for successfully performing each sub-task and completing the overall task.

In an exemplary embodiment, in many organizations, end-to-end tasks are divided across teams with differing roles. For example, one task may entail gathering information and creating a client record for client onboarding, a common task performed in many organizations. This end-to-end task may be accomplished by several teams that need to interact often with each other and with external clients. From an organizational design perspective, the end-to-end client onboarding may be split across different functional teams, for example, sales, KYC, credit, legal, and data. Within each function, a team may be further split into different specialty teams. For example, a KYC team may constitute several types of functional roles that work together to create a client's KYC record.

In an exemplary embodiment, when end-to-end automation is introduced, an AI-based solution may take away the conventional rule-based aspects across several of these roles and functions, thus presenting an opportunity to reimagine how the task may be accomplished under a new organizational construct. One option is to proportionally reduce a human footprint for each role. An alternative option is to merge certain roles, and replace these with a role (i.e., as defined by employee skills and function) that involves primarily dealing with nuances and subjectivity. The latter leads to a role performed by employees with broader context, less communication burden, and with support from AI for rule-based tasks. Such a role may be better empowered to perform the end-to-end task. Note that this end-to-end role may not have been practically feasible before the use of AI because of several practical limitations, including a cognitive burden of accessing a multitude of applications and systems, deep expertise required for certain rule-based analyses leading to specialists with primary focus, ability to hire and retain employees that have strong skills with respect to both rule-based and higher level cognitive tasks, and marked compensation and location differences for employees that specialize in subjective versus rule-based tasks. With support from AI for the rule-based aspects, these practical limitations may be significantly alleviated, and hence provide motivations for organizational design optimization and re-skilling.

Another consideration that emerges with the deployment of AI is that it may change aspects and/or requirements for dependent roles. For example, in the KYC use case, if AI performs parts of a maker job function, a checker role and/or job function will also need to change. This is because the kinds of errors humans make versus the kinds of errors machines make, which are categorically different. As a special case, certain roles may be 100% replaced by AI, thus leading to opportunities to reimagine a new orchestration of roles to achieve the end-to-end task.

Irrespective of motivations, whether driven by advent of AI and digitization, or simply a desire to continually optimize, in an exemplary embodiment, the key idea is to use signals from firm data to drive organization design. Organization design may be thought of a manifestation of orchestration of subtasks accomplished as roles that together accomplish an end-to-end task. Firms may optimize their organizations by creating specialist teams and keeping heavily dependent teams and/or roles structurally close. Tasks that need to be performed in sequence versus parallel may also drive design. For example, tasks that can be accomplished in parallel may be setup as hub and spoke structures to speed up, while sequential tasks may be linear structures.

In practice, role and task definitions evolve with time, and teams may be burdened with heavy dependencies leading to suboptimal design. Thus, in an exemplary embodiment, the systems and methods described herein would enable firms leverage the following data to optimize their organization design in a data driven manner.

Team Analysis—1) Input analysis: What is the category/volume/nature of input that each team receives? For sake of argument, the answer to this question is denoted herein as X. 2) Task/function/role analysis: What is the control and/or task performed by a person, also referred to herein as a “role”. For sake of argument, the role may be understood of as a function ƒ in ƒ(X) to which the role applies. 3) Skill analysis: What are the skills needed to perform role/function ƒ.

End-to-End Task Analysis—1) Outcomes analysis, including a quality of end-to-end task, an amount of time taken, overlapping task analysis, and any other suitable result of analyzing an outcome of the completed task. 2) Collaboration/communication across roles/jobs/functions: inter-team and intra-team message analysis, including themes, volume, sentiment, possibility of confusion, and other aspects of communication.

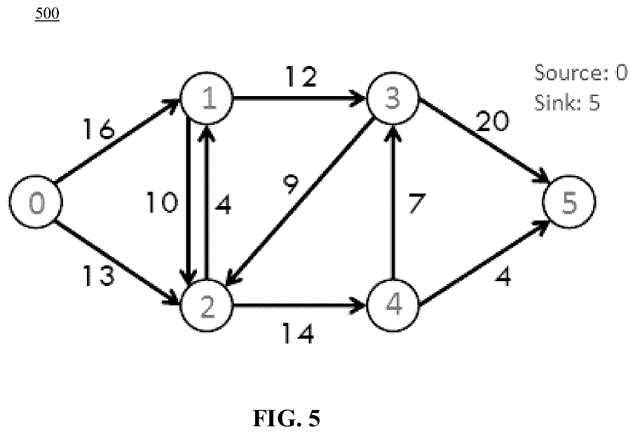

FIG. 5 is a graphical depiction 500 of an organizational design that is usable for performing a method for optimizing a design of an organization by using AI-based automation to orchestrate a structure of jobs, roles, and task assignments so as to improve business outcomes, according to an exemplary embodiment

In an exemplary embodiment, the systemization of organizational design may be performed in four steps.

Step 1: Decompose organizational design into a graph. An organization design (O) may be defined as a function of people <skills, number>, tasks <rule based/subjective nature, skills required to complete task>, and interactions <people/team organization, dependence/sequence between sub-tasks>:

A task is usually completed end-to-end by involving a number of teams that have varied specializations and/or skills. Referring to FIG. 5, one such depiction 500 of an organization using a graph structure is illustrated.

In the graph representation 500, a node n_{x,y,z} represents a team that has x number of people, with y being a vector of specializations required to complete a subtask z. A directed edge E_{s,t,c} represents a flow of work from node s to node t, where capacity c is the maximum unit of tasks (i.e., volume) that can be sent from node s to node t. Note that without loss of generalizability, it may be assumed that a sub-task is performed by a node. The directions represent sequential constraints that exist between sub-tasks that are required for the successful completion of the overall task. Cycles are possible, and depict realistic scenarios.

In practice, while team size and hierarchies may be readily available using organizational data, a task decomposition into sub-tasks is not generally readily available, and mappings between teams and sub-tasks are also not generally readily available. Such mappings can be created by using a variety of methods, depending on the exact nature of the task. For example, an organization may be focused on responding to email queries. Leveraging historical email data, and natural language processing (NLP) techniques, it is possible to extract the names of various responders and their respective roles in sub-task completion. For technology related tasks, such mappings can be created by mapping tasks in task management systems like JIRA with the names of engineers who pushed code or resolved incidents, etc.

Such analysis also allows for discovery of dependencies between subtasks, as they will be manifested by sequences of responders or explicitly identified in task planning systems. These dependencies will form the directed edges,

Next, the capacity of each edge is computed. This capacity can be obtained by capturing business data for time completion for each sub-task by each team.

Step 2: Establish a business criterion (i.e., objective function) to optimize. Establish methods to compute business criterion. Establish business constraints.

An organization may be seeking to optimize certain criteria. For example, the organization may be looking to reduce cost, increase timeliness, maximize worker efficiency, enhance client experience, reduce risk, minimize dependency between teams (i.e., minimize hops), and/or enhance employee satisfaction. One can infer/compute the values associated with each respective criterion based on node cost, full task completion cost, skills cost, number of hops, and/or time taken by applying statistical computations on business data that is typically available.

In an exemplary embodiment, given an initial organizational graph structure, a Ford Fulkerson algorithm may be used for computing the overall capacity for the graph. A maximum flow plus minimum cut may be calculated in order to determine the maximum capacity possible with the structure.

Step 3: Use generative AI to generate new designs that optimize the stated business criterion. In an exemplary embodiment, generative AI may be used for design of physical objects and spaces. Such designs typically optimize physical constructs like air circulation, strength of individual components, and/or a holding capacity of an object. In an exemplary embodiment, a novel method for using generative AI for design of knowledge based organizations to enable optimization of knowledge workers organizational criterion is disclosed.

New graph designs may be generated by using optimization techniques that learn from experience, such as, for example, genetic algorithms and Ant Colony optimization. For each new graph, a value for the objective function may computed as described above with respect to Step 2. Given optimization algorithms that are based on experience, AI initially generates a number of permutations as described by the freedom of the parameter space (i.e., parameter perturbations), and over time the new designs converge to ones that consistently optimize the objective function criterion. One can potentially stop at this stage. In the next stage AI suggests actions that leaders can take to further optimize their organizations.

Step 4: Use of AI to create counterfactuals that suggest changing constraints in a way that further optimizes the business criterion objective function. Identify opportunities to further evolve organization.

Counterfactuals utilize feature perturbations to analyze the outcome of an original decision and recommend an actionable recourse. Using counterfactuals, AI can generate new designs with the new criterion. These include at least three types of insights and suggested actions.

The first type of insight relates to a graph structure redesign. For example, AI may find that if a particular node's capacity could be increased slightly, this would lead to a disproportionate increase in the overall graph. In this case, suggested actions may include hiring a particular number of people with specific skills to perform the respective subtask.

As another example, in a particular graph, it may be a case that there is unused capacity, and while a node is performing highly because of additional capacity, subsequent capacity overflow causes a lower flow. In this case, leaders may look at reducing high performant node capacity in case it exceeds criterion. This is an example of identifying and reducing spare capacity.

As a third example, a graph structure redesign may entail any one or more of moving certain dependencies through graph structure optimization, identifying areas to cut the graph into sub-graphs to reduce hops, identifying new sequencing flows, and/or creating new dedicated specializations to optimize capacity.

The second type of insight relates to use of an AI worker. An AI worker presents an interesting special case, in that the AI worker offers infinite capacity for the sub-tasks that the AI worker can automate. In this case, productivity can obtained by reducing hops and automating human tasks. Using counterfactual explanations one can identify best opportunities of automation using AI, by identifying nodes that are rule based sub-tasks and causing flow starvation. These starved nodes would lead to maximal acceleration of capacity increase.

The third type of insight relates to identifying other opportunities in the organization by detecting anomalies. Pockets of slowness or excellence may be identified by measuring and comparing workers' variability of performance on similar tasks. This gives an opportunity to learn from characteristics of skills from higher performing groups and then to apply the results thereof to slower groups.

Accordingly, with this technology, a process for optimizing a design of an organization by using AI-based automation to orchestrate a structure of jobs, roles, and task assignments so as to improve business outcomes is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for optimizing a design of an organization, the method being implemented by at least one processor, the method comprising:
receiving, by the at least one processor, a first task description that includes information that relates to each of a plurality of sub-tasks;
analyzing, by the at least one processor, the first task description; and
generating, by the at least one processor based on a result of the analyzing, a task management plan that includes information that relates to a respective personnel assignment and a respective schedule for each respective sub-task of the plurality of sub-tasks.

2. The method of claim 1, wherein the analyzing of the first task description comprises applying an artificial intelligence (AI) algorithm that uses a machine learning technique to analyze each respective sub-task of the plurality of sub-tasks.

3. The method of claim 2, wherein the AI algorithm is trained by using historical data that relates to a predetermined set of previously completed tasks.

4. The method of claim 3, wherein the generating of the task management plan comprises optimizing the task management plan with respect to at least one predetermined criterion,
wherein the at least one predetermined criterion includes at least one from among reducing cost, increasing timeliness, maximizing worker efficiency, enhancing client experience, reducing risk, minimizing inter-team dependency, and enhancing employee satisfaction.

5. The method of claim 1, wherein the first task description includes a description of a task that includes at least one know-your-customer (KYC) functionality to be performed in a course of onboarding a new client.

6. The method of claim 1, wherein the first task description includes a description of a task that includes at least one client inquiry resolution functionality to be performed in a course of responding to a client inquiry.

7. The method of claim 1, wherein the analyzing comprises assessing a volume of communications required among persons assigned to perform the plurality of sub-tasks.

8. The method of claim 7, wherein the task management plan includes information that relates to communications requirements for performing the plurality of sub-tasks.

9. The method of claim 1, wherein the analyzing comprises determining, for each respective one of the plurality of sub-tasks, whether the respective sub-task is performable in parallel with other sub-tasks from among the plurality of sub-tasks.

10. The method of claim 1, wherein the analyzing comprises:
determining, for each respective one of the plurality of sub-tasks, a corresponding skill set that is required for performing the respective sub-task; and
identifying at least one person that possesses the corresponding skill set.

11. A computing apparatus for optimizing a design of an organization, the computing apparatus comprising:
a processor;
a memory; and
a communication interface coupled to each of the processor and the memory,
wherein the processor is configured to:
receive, via the communication interface, a first task description that includes information that relates to each of a plurality of sub-tasks;
analyze the first task description; and
generate, based on a result of the analysis, a task management plan that includes information that relates to a respective personnel assignment and a respective schedule for each respective sub-task of the plurality of sub-tasks.

12. The computing apparatus of claim 11, wherein the processor is further configured to analyze the first task description by applying an artificial intelligence (AI) algorithm that uses a machine learning technique to analyze each respective sub-task of the plurality of sub-tasks.

13. The computing apparatus of claim 12, wherein the AI algorithm is trained by using historical data that relates to a predetermined set of previously completed tasks.

14. The computing apparatus of claim 13, wherein the processor is further configured to optimize the task management plan with respect to at least one predetermined criterion,
wherein the at least one predetermined criterion includes at least one from among reducing cost, increasing timeliness, maximizing worker efficiency, enhancing client experience, reducing risk, minimizing inter-team dependency, and enhancing employee satisfaction.

15. The computing apparatus of claim 11, wherein the first task description includes a description of a task that includes at least one know-your-customer (KYC) functionality to be performed in a course of onboarding a new client.

16. The computing apparatus of claim 11, wherein the first task description includes a description of a task that includes at least one client inquiry resolution functionality to be performed in a course of responding to a client inquiry.

17. The computing apparatus of claim 11, wherein the processor is further configured to assess a volume of communications required among persons assigned to perform the plurality of sub-tasks.

18. The computing apparatus of claim 17, wherein the task management plan includes information that relates to communications requirements for performing the plurality of sub-tasks.

19. A non-transitory computer readable storage medium storing instructions for optimizing a design of an organization, the storage medium comprising executable code which, when executed by a processor, causes the processor to:
receive a first task description that includes information that relates to each of a plurality of sub-tasks;
analyze the first task description; and
generate, based on a result of the analysis, a task management plan that includes information that relates to a respective personnel assignment and a respective schedule for each respective sub-task of the plurality of sub-tasks.

20. The storage medium of claim 19, wherein when executed by the processor, the executable code further causes the processor to analyze the first task description by applying an artificial intelligence (AI) algorithm that uses a machine learning technique to analyze each respective sub-task of the plurality of sub-tasks.
